(19) United States
(12) Patent Application Publication
(10) Pub. No.: US 2025/0369595 A1
(43) Pub. Date: Dec. 4, 2025

(54) ANGLE ADJUSTABLE STRUCTURE AND LED WALL LIGHT

(71) Applicant: MESTER LED LIMITED, Shenzhen (CN)

(72) Inventor: Erhua MA, Shenzhen (CN)

(73) Assignee: MESTER LED LIMITED, Shenzhen (CN)

(21) Appl. No.: 18/828,244

(22) Filed: Sep. 9, 2024

(30) Foreign Application Priority Data
May 31, 2024 (CN) 202421246473.5

(51) Int. Cl. F21V 14/02; F21S 8/00; F21V 29/70; F21V 31/00; F21Y 115/10

(52) U.S. Cl. CPC F21V 14/02; F21S 8/033; F21V 29/70; F21V 31/005; F21Y 2115/10

(57) ABSTRACT

Disclosed are an angle adjustable structure and a light emitting diode (LED) wall light. The angle adjustable structure includes a lamp body shell, a heat dissipation component, a first connecting member, a limit rotating member, a gear member, a gear member, and a second connecting member. One end of the heat dissipation component is configured to cooperate with the lamp body shell through the first connecting member to form a non-embedded fixed structure, and the other end of the heat dissipation component is configured to cooperates with the lamp body shell through the limit rotating member, the gear member, the elastic member and the second connecting member to form an embedded fixed structure.

### CROSS-REFERENCE TO RELATED APPLICATIONS

This application claims priority to Chinese Patent Application No. 202421246473.5, filed on May 31, 2024, the entire contents of which are incorporated herein by reference.

### TECHNICAL FIELD

The present application relates to the technical field of lighting, and in particular to an angle adjustable structure and an LED wall light.

### BACKGROUND

Wall lamps are decorative lamps installed on indoor walls for auxiliary lighting, usually equipped with milky white glass lampshades. The light is elegant and harmonious, which can decorate the environment elegantly and gorgeously, and is suitable for newlyweds' rooms. There are many types and styles of wall lamps, generally, the common ones are ceiling lamps, color-changing wall lamps, bedside wall lamps, mirror wall lamps, etc.

Traditionally, when wall lamps are installed against the wall, they are often installed against the wall at a fixed angle, and the lighting distance and range are single. Although some existing lamps on the market have angle adjustment functions, they are often adjusted by changing the external structure, and the adjustment accuracy is poor. It cannot meet the lighting needs in different situations and affects the appearance of the lamp. In response to the above problems, no effective solution has been provided so far.

### SUMMARY

The main purpose of the present application is to provide an angle adjustable structure and a light emitting diode (LED) wall light, aiming to solve the above-described problem.

To achieve the above purpose, the present application provides an angle adjustable structure, including: a lamp body shell, a heat dissipation component, a first connecting member, a limit rotating member, a gear member, a gear member, and a second connecting member. The heat dissipation component disposed in the lamp body shell. The first connecting member is at least partially connected to one end of the heat dissipation component along a first direction. The limit rotating member is provided concentrically with the first connecting member along the first direction, and the limit rotating member is connected to one end of the heat dissipation component away from the first connecting member. The gear member is sleeved on the limit rotating member, and one side of the gear member is meshed with the limit rotating member. The elastic member is sleeved on the limit rotating member, and the elastic member is abutted against a side of the gear component away from the limiting rotating component. The second connecting member is penetrated and embedded in the limit rotating member and is at least partially connected to one end of the heat dissipation component away from the first connecting member. One end of the heat dissipation component is configured to cooperate with the lamp body shell through the first connecting member to form a non-embedded fixed structure, and the other end of the heat dissipation component is configured to cooperate with the lamp body shell through the limit rotating member, the gear member, the elastic member and the second connecting member to form an embedded fixed structure.

In an embodiment, an inner wall of the limit rotating member is evenly provided with a plurality of first teeth along a circumferential direction of the limit rotating member; the gear member is evenly provided with a plurality of second teeth along a circumferential direction of the gear member, and the first teeth on the limit rotating member are respectively meshed with the second teeth on the gear member.

In an embodiment, the first connecting member includes a first portion and a second portion; a limiting recess is provided on one side of the lamp body shell, and the limiting recess includes a first limiting recess and a second limiting recess; the first limiting recess is configured to accommodate the first portion, and the second limiting recess is configured to accommodate the second portion.

In an embodiment, a depth of the first limiting recess is greater than a depth of the second limiting recess.

In an embodiment, the limiting recess is provided with a limiting baffle, and the limiting baffle is configured to limit the first connecting member.

In an embodiment, a limiting hole matching with the limit rotating member is provided on a side of the lamp body shell away from the first connecting member.

In an embodiment, at least one step is provided at the limiting hole.

In an embodiment, a bottom of the limiting hole is provided with an annular protrusion, and the annular protrusion is configured to cooperate with the at least one step to form a limiting groove.

In an embodiment, an inner wall of the at least one step is provided with a first limit clamp for limiting the limit rotating member and a second limit clamp for limiting the gear member.

In an embodiment, a limiting protrusion is provided at one end of the heat dissipation component close to the limit rotating member, and the limiting protrusion is plugged into the bottom of the limit rotating member; at least one positioning protrusion is provided at the limiting protrusion; at least one positioning recess is provided at the bottom of the limit rotating member, and each positioning protrusion is respectively engaged in a corresponding positioning recess.

In an embodiment, an outer surface of the limit rotating member is provided with a marking arrow corresponding to the positioning recess.

In the technical solution of the present application, one end of the heat dissipation component is configured to cooperate with the lamp body shell through the first connecting member to form a non-embedded fixed structure, and the other end of the heat dissipation component is configured to cooperate with the lamp body shell through the limit rotating member, the gear member, the elastic member and the second connecting member to form an embedded fixed structure. Based on the above embedded fixed structure and non-embedded fixed structure, the present application can make the angle of the heat dissipation component adjustable. The angle adjustment is more accurate and the service life of the lamp is extended.

### BRIEF DESCRIPTION OF THE DRAWINGS

FIG. 1 is a schematic structural view of an angle adjustable structure according to an embodiment of the present application.

FIG. 2 is a schematic structural view of the angle adjustable structure according to another embodiment of the present application.

FIG. 3 is a side view of the angle adjustable structure according to an embodiment of the present application.

FIG. 4 is an exploded view of the angle adjustable structure according to an embodiment of the present application.

FIG. 5 is an internal structure view of the angle adjustable structure of the angle adjustable structure according to an embodiment of the present application.

FIG. 6 is a schematic structural view of a lamp body shell of the angle adjustable structure according to an embodiment of the present application.

FIG. 7 is a side view of the lamp body shell of the angle adjustable structure according to an embodiment of the present application.

FIG. 8 is a schematic structural view of a heat dissipation component of the angle adjustable structure according to an embodiment of the present application.

FIG. 9 is a main view of the heat dissipation component of the angle adjustable structure according to an embodiment of the present application.

FIG. 10 is a schematic structural view of a limit rotating part of the angle adjustable structure according to an embodiment of the present application.

FIG. 11 is a schematic structural view of the limit rotating part of the angle adjustable structure according to another embodiment of the present application.

FIG. 12 is a schematic structural view of a gear member of the angle adjustable structure according to an embodiment of the present application.

FIG. 13 is an assembly view of the limit rotating part and the gear member of the angle adjustable structure according to an embodiment of the present application.

FIG. 14 is a two-dimensional (2D) schematic structural view of the limit rotating part of the angle adjustable structure according to an embodiment of the present application.

### DETAILED DESCRIPTION OF THE EMBODIMENTS

The technical solutions in the embodiments of the present application will be clearly and completely described below with reference to the drawings in the embodiment of the present application. Obviously, the described embodiments are only a part of the embodiments of the present application, not all of the embodiments. Based on the embodiments in the present application, all other embodiments perceived by those skilled in the art without creative effort should be fallen within the protection scope of the present application.

It should be noted that the terms “first”, “second”, etc. in the specification and claims of the present application and the above-mentioned drawings are used to distinguish similar objects, and are not necessarily used to describe a specific order or sequence. It should be understood that the data used in this way can be interchanged under appropriate circumstances, so that the embodiments of the present application described herein. In addition, the terms “including” and “having” and any of their variations are intended to cover non-exclusive inclusions, for example, a process, method, system, product or device that includes a series of steps or units is not necessarily limited to those steps or units clearly listed, but may include other steps or units that are not clearly listed or inherent to these processes, methods, products or devices.

In addition, the terms “install”, “set”, “provided with”, “connected”, “connected”, and “socketed” should be understood in a broad sense. For example, it can be a fixed connection, a detachable connection, or an integral structure; it can be a mechanical connection, or an electrical connection; it can be directly connected, or indirectly connected through an intermediate medium, or it can be an internal connection between two devices, elements or components. For those skilled in the art in this field, the specific meanings of the above terms in the present application can be understood according to the specific circumstances.

It should be noted that the embodiments and features in the embodiments in the present application can be combined with each other without conflict. The present application will be described in detail below with reference to the accompanying drawings and in combination with embodiments.

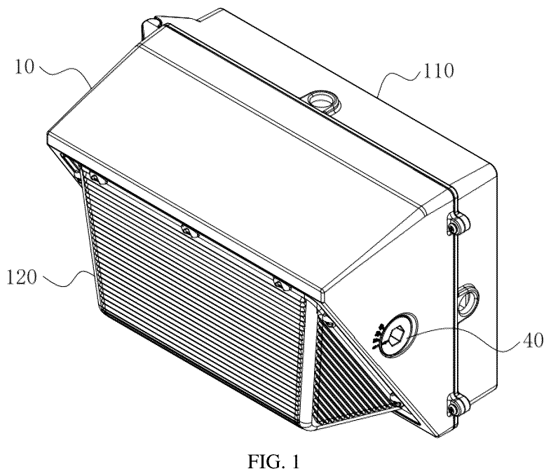

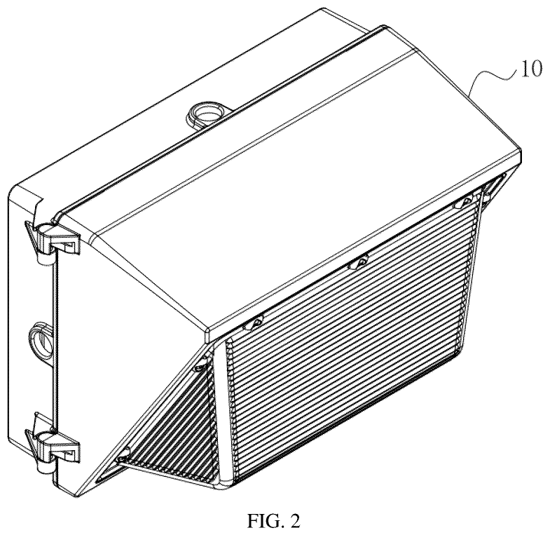

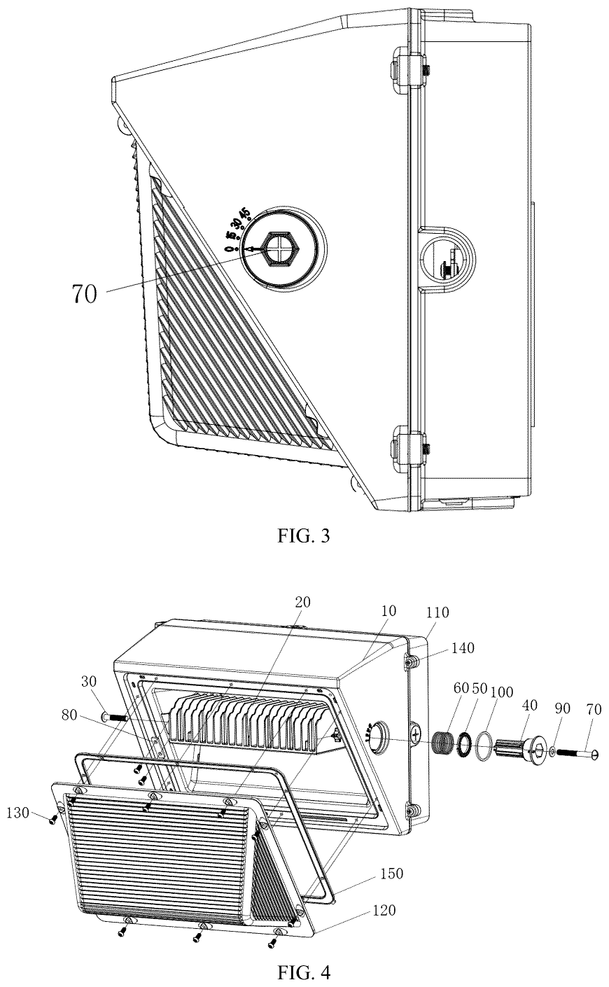

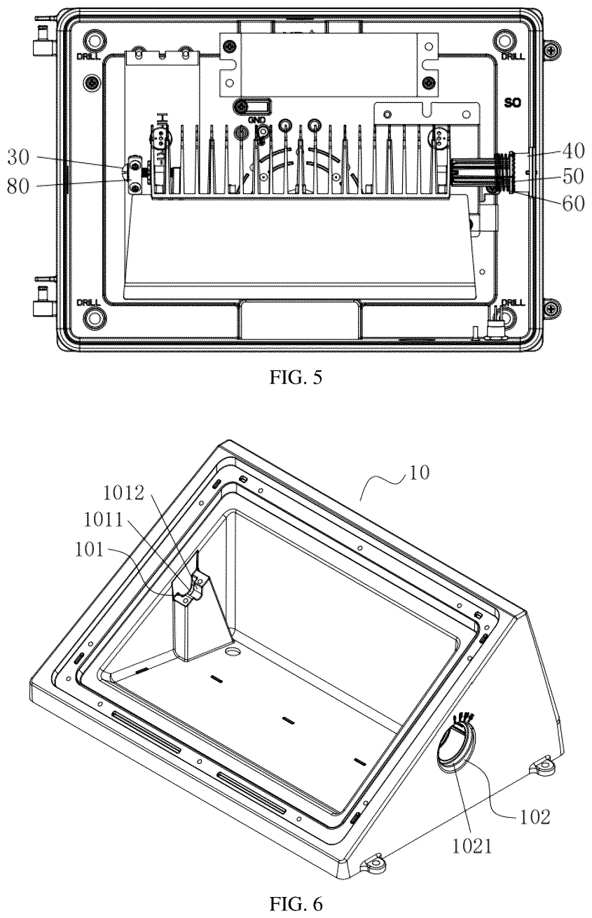

As shown in FIG. 1 to FIG. 5, the present application provides an angle adjustable structure, and the angle adjustable structure includes a lamp body shell, a heat dissipation component, a first connecting member, a limit rotating member, a gear member, a gear member, and a second connecting member. The lamp body shell 10 refers to the surface shell of the lamp body, and the lamp body shell 10 can protect lamp body and also has an aesthetic effect. In the present application, the lamp body shell 10 can be in a triangular shape, which can achieve a good coordination effect with other components, thereby ensuring a good brightness presentation effect. In order to adapt to a variety of usage environments, the shape of the lamp body shell 10 can be formulated according to actual usage requirements, and is not limited in the present application. The material of the lamp body shell 10 includes but is not limited to: plastic, aluminum alloy or glass.

In an embodiment, the heat dissipation component 20 is disposed in the lamp body shell 10. The heat dissipation component 20 has a good heat conduction effect, thereby ensuring that the light source such as the light emitting diode (LED) can work normally and the service life of the light source can be extended. In the present application, the heat dissipation component 20 is an independent heat sink, and the usage of an independent heat sink can improve the heat dissipation performance. At least one heat dissipation fin is provided space apart on the heat dissipation component 20, and the setting of the heat dissipation fin can ensure a good heat dissipation effect.

In an embodiment, the first connecting member 30 is at least partially connected to one end of the heat dissipation component 20 along the first direction. The first connecting member 30 is a shaft screw; the lamp body shell 10 is connected to one end of the heat dissipation component 20 through the first connecting member 30, and the lamp body shell 10 is configured to rotate relative to the heat dissipation component 20. Therefore, the present application provides a limited locking seat at one end of the heat dissipation component 20 to prevent the lamp body shell 10 from rotating relative to the heat dissipation component 20. In addition, in order to prevent the stroke of the first connecting member 30 from being too long, the present application also adds a limit block to the heat dissipation component 20, and the limit block is abutted against the end of the first connecting member 30 to adjust the stroke of the first connecting member 30. The first direction refers to the layout extension direction of at least one heat dissipation fin in the heat dissipation component 20.

The limit rotating member 40 is provided concentrically with the first connecting member 30 along the first direction, and the limit rotating member 40 is connected to one end of the heat dissipation component 20 away from the first connecting member 30. The limit rotating member 40 can be a turntable. Through assembling the limit rotating member 40 at one end of the heat dissipation component 20, the rotation angle between the lamp body shell 10 and the heat dissipation component 20 can be accurately adjusted. The limit rotating member 40 and the first connecting member 30 are provided concentrically, which can ensure a good transmission effect between the limit rotating member 40 and the first connecting member 30.

The outer surface of the limit rotating member 40 is provided with a hexagonal groove to ensure a good force application effect.

The gear member 50 is sleeved on the limit rotating member 40, and one side of the gear member 50 away from the first connecting member 30 is meshed with the limit rotating member 40, which can make the assembly effect between the gear member 50 and the limit rotating member 40 better, thereby facilitating accurate angle limitation. At the same time, the gear meshing connection is adopted, so that the lamp body shell 10 and the heat dissipation component 20 can have multiple adjustable angles.

The elastic member 60 is sleeved on the limit rotating member 40. The elastic member 60 is abutted against a side of the gear member 50 close to the first connecting member 30. The elastic member 60 is also abutted against an end of the heat dissipation member 20 away from the first connecting member 30. The setting of the elastic member 60 can limit and fix the gear member 50, thereby ensuring that the gear member 50 is in a stable state, and further ensuring that the heat dissipation member 20 is not easy to loosen. In the present application, the elastic member 60 can be a spring.

The second connecting member 70 is penetrated and embedded in the limit rotating member 40 and is at least partially connected to the end of the heat dissipation component 20 away from the first connecting member 30. The second connecting member 70 is a first fixing screw for fixing the limit rotating member 40. The first fixing screw can ensure that the connection between the limit rotating member 40, the gear member 50, the elastic member 60 and the heat dissipation component 20 is relatively stable.

One end of the heat dissipation component 20 is configured to cooperate with the lamp body shell 10 through the first connecting member 30 to form a non-embedded fixed structure, and the end of the heat dissipation component away from the first connecting member 30 is configured to cooperate with the lamp body shell 10 through the limit rotating member 40, the gear member 50, the elastic member 60, and the second connecting member 70 to form an embedded fixed structure.

The angle adjustable structure also includes a shaft fixing plate, and the shaft screw can be fixed to one end of the heat dissipation component 20 through the shaft fixing plate. The shaft fixing plate, the shaft screw and the lamp body shell 10 are not fixed in an embedded manner, which can ensure that the connection between the heat dissipation component 20 and the lamp body shell 10 is relatively stable.

In the technical solution of the present application, one end of the heat dissipation component is configured to cooperate with the lamp body shell through the first connecting member to form a non-embedded fixed structure, and the other end of the heat dissipation component is configured to cooperate with the lamp body shell through the limit rotating member, the gear member, the elastic member and the second connecting member to form an embedded fixed structure. Based on the above embedded fixed structure and non-embedded fixed structure, the present application can make the angle of the heat dissipation component adjustable. The angle adjustment is more accurate, and the service life of the lamp is extended.

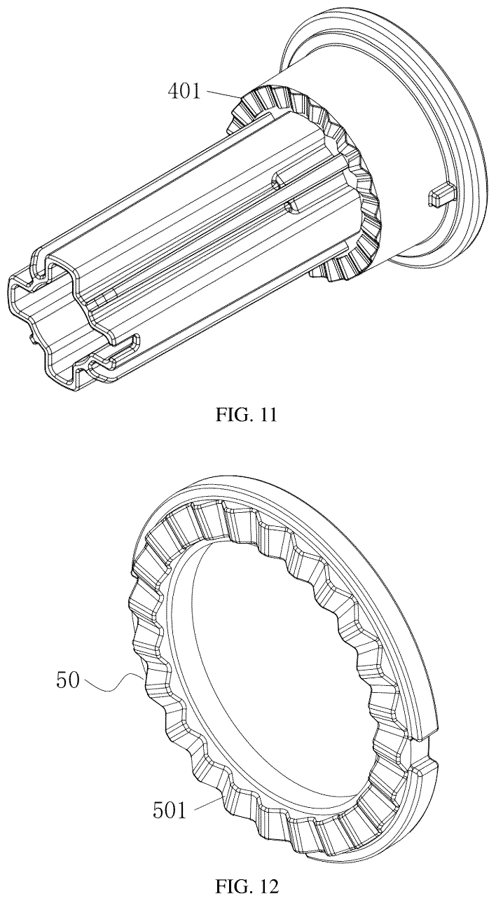

As shown in FIG. 10 to FIG. 12, an inner wall of the limit rotating member 40 is evenly provided with a plurality of first teeth 401 along the circumferential direction of the limit rotating member 40. The gear member 50 is evenly provided with a plurality of second teeth along the circumferential direction of the gear member 50. Each of the first teeth 401 on the limit rotating member 40 is meshed with each of the second teeth 501 on the gear member 50.

The limit rotating member 40 is adjusted to a preset position, and the limit rotating member 40 is configured to drive the heat dissipation component 20 to rotate to a corresponding position. Since the second teeth 501 are meshed with the first teeth 401, after the heat dissipation component 20 rotates to the corresponding position, the heat dissipation component 20 can be fixed at the position. The limit rotating member 40 is meshed with the gear member 50 through the tooth structure. When the limit rotating member 40 is rotated, the first teeth 401 on the limit rotating member 40 rotates accordingly, and the first teeth 401 is meshed with the second teeth 501, so that the gear member 50 rotates accordingly. This arrangement can make the heat dissipation component 20 rotates a corresponding angle, so that the desired lighting angle can be obtained. At the same time, when the first gear 401 is at a preset angle, the second gear 501 limits and fixes the first gear 401 to keep it in its current state and angle, thereby avoiding returning or resetting, and affecting the accuracy of adjusting the angle. In addition, the elastic component 60 is abutted against one end of the second gear 50 and is also abutted against the inner wall of the lamp body shell 10 to ensure that the second gear 501 is in a stable state and is not easy to loosen.

In order to obtain the required rotation angle, the quantity of teeth of the first teeth in the limit rotating member 40, and the quantity of teeth of the second teeth in the gear member 50 can be set according to the required rotation angle. The present application does not limit this herein.

The first connecting member 30 includes a first portion and a second portion. The first portion can be a nut, and the second portion can be a stud. A semi-open limiting recess 101 is provided on one side of the lamp body shell 10, and the limiting recess 101 is configured to accommodate the first connecting member 30. The limiting recess 101 includes a first limiting recess 1011 and a second limiting recess 1012. The first limiting recess 1011 is configured to accommodate the first portion, and the second limiting recess 1012 is configured to accommodate the second portion.

The depth of the first limiting recess 1011 is greater than the depth of the second limiting recess 1012, which can avoid interference.

The limiting recess 101 is provided with a limiting baffle 80 for limiting the first connecting member 30. The limiting baffle 80 is provided on the limiting recess 101, and the degree of freedom of the first connecting member 30 can be limited to obtain the desired motion state of the first connecting member 30.

The limiting baffle 80 can be connected to the first connecting member 30 through a second fixing screw, so that the limiting baffle 80 is detachable. In addition, the limiting baffle 80 can be rectangular in shape. The quantity of the second fixing screws can be at least two to ensure that the connection between the limiting baffle 80 and the first connecting member 30 is relatively stable.

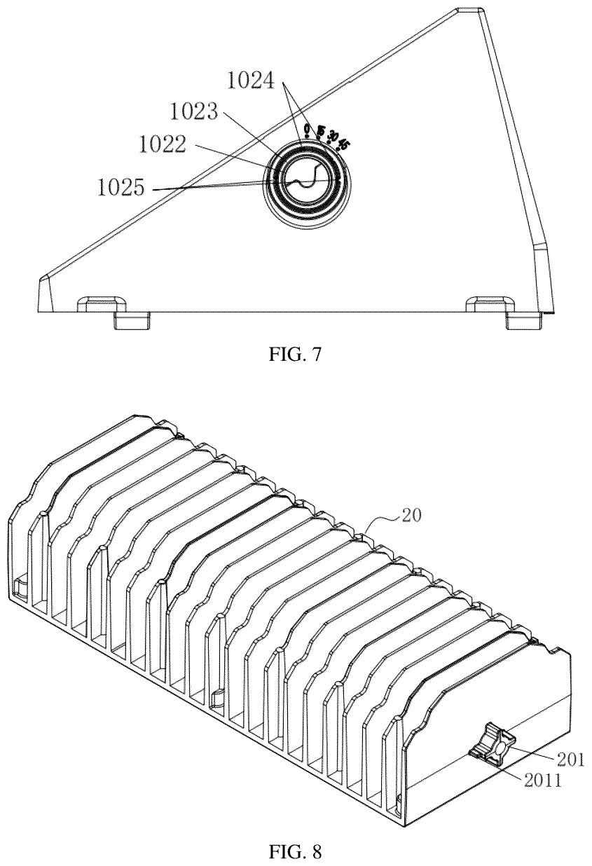

As shown in FIG. 6 to FIG. 7, a limiting hole 102 matching with the limit rotating member 40 is provided on the side of the lamp body shell 10 away from the first connecting member 30. The limiting hole 102 is provided on the lamp body shell 10, and a better assembly effect between the lamp body shell 10 and the limit rotating member 40 can be ensured.

In an embodiment, the present application can also add another limiting hole on the lamp body shell 10, and correspondingly add related components such as the limit rotating member 40. Similarly, the limiting hole 102 on another side also has the function of adjustable angle, which will not be described in detail here.

At least one step is provided at the limiting hole 102. It is understandable that the limiting hole 102 is designed in a stepped shape, which can further enhance the stability of the assembly between the lamp body shell 10 and the limit rotating member 40. In the case of a plurality of steps 1021, the diameters of the plurality of steps 1021 increase from the inside to the outside, which can ensure that the limit rotating member 40 is better embedded in the limiting hole 102.

The bottom of the limiting hole 102 is provided with an annular protrusion 1022 extending from the inside to the outside, and the annular protrusion 1022 is configured to cooperate with the at least one step 1021 to form a limiting groove 1023. Such setting enables the elastic component 60 can be limited, thereby ensuring that the elastic component 60 stably acts on one side of the gear member 50.

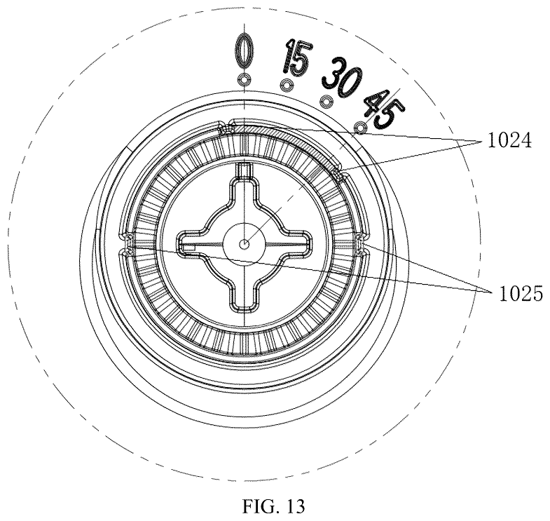

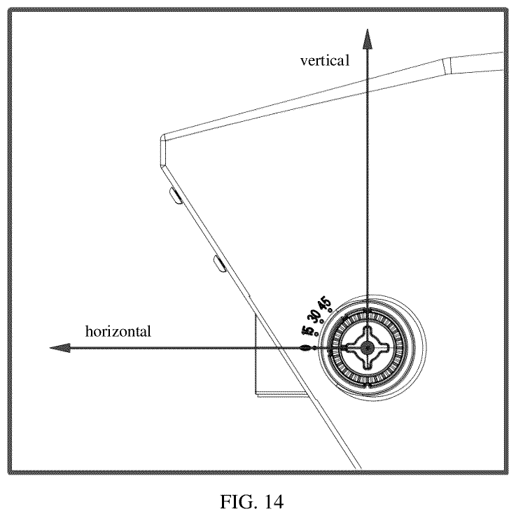

As shown in FIG. 13 and FIG. 14, the inner wall of the at least one step 1021 is provided with a first limit clamp 1024 for limiting the limit rotating member 40 and a second limit clamp 1025 for limiting the gear member 50. This arrangement can ensure that the limit rotating member 40 rotates to the required angle.

There can be two first limit clamps, and the sector area formed between the two first limit clamps 1024 can be used to limit the limit rotating member 40, such as the sector area of 0°-45° in the figure. There can be two second limit clamps, and the two second limit clamps 1025 can limit the gear member 50.

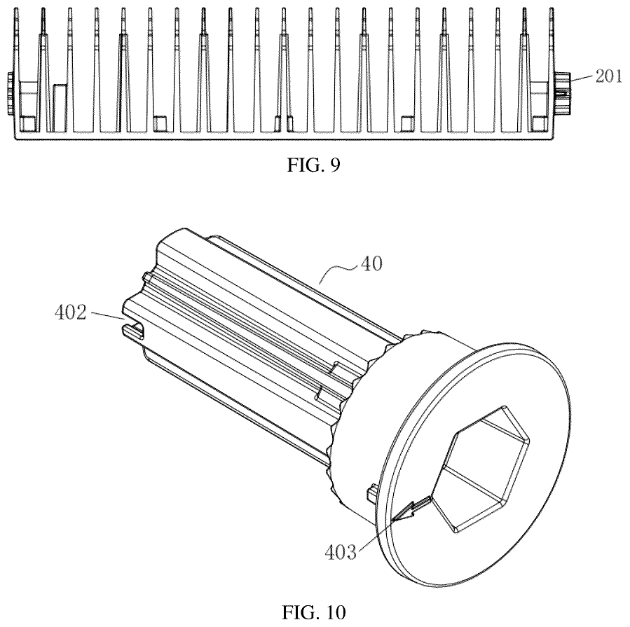

As shown in FIG. 8 and FIG. 9, a cross-shaped limiting protrusion 201 is provided at one end of the heat dissipation component 20 close to the limit rotating member 40, and the limiting protrusion 201 is plugged into the bottom of the limit rotating member 40. At least one positioning protrusion 2011 is also provided at the limiting protrusion 201; at least one positioning recess 402 is provided at the bottom of the limit rotating member 40, and each positioning protrusion 2011 is respectively engaged in a corresponding positioning recess 402. In this way, the limit rotating member 40 can be more stably connected to the lamp body shell 10.

The outer surface of the limit rotating member 40 is provided with a marking arrow 403 corresponding to the positioning recess 402, and the marking arrow 403 corresponds to the scale on the lamp body shell 10. The scale on the lamp body shell 10 represents the angle value of the heat dissipation component 20 relative to the horizontal plane. The outer surface of the limit rotating member 40 is also provided with a plurality of angle scales. The angle scales include but are not limited to: 0°, 15°, 30° and 45°. A marking arrow 403 is provided on the limit rotating member 40, so that the user can check the state of the limit rotating member 40.

For example, the scale indicates that the angle value of the heat dissipation component 20 relative to the horizontal plane is 0°, and the angle between the light-emitting surface and the vertical direction is 0°. The scale indicates that the angle value of the heat dissipation component 20 relative to the horizontal plane is 15°, and the angle between the light-emitting surface and the vertical direction is 75°. The scale indicates that the angle value of the heat dissipation component 20 relative to the horizontal plane is 30°, and the angle between the light-emitting surface and the vertical direction is 60°. The scale indicates that the angle value of the heat dissipation component 20 relative to the horizontal plane is 45°, and the angle between the light-emitting surface and the vertical direction is 45°.

A first waterproof ring 90 is provided between the limit rotating member 40 and the second connecting member 70, and a second waterproof ring 100 is provided between the limit rotating member 40 and the lamp body shell 10. The first waterproof ring 90 can prevent water from entering between the limit rotating member 40 and the second connecting member 70, and the second waterproof ring 100 can prevent water from entering between the limit rotating member 40 and the lamp body shell 10, thereby preventing water from entering the lamp, which is beneficial to improving the service life of the lamp.

The working principle of the angle adjustable structure described above is as follows.

The limit rotating member 40 is meshed with the gear member 50, and the gear member 50 is connected to the lamp body shell 10 through the elastic member 60. When the limit rotating member 40 rotates under the action of external force, the limit rotating member 40 is configured to drive the gear member 50 to rotate, and the elastic force of the elastic member 60 causes the gear member 50 to move in the vertical direction and make a yielding action. When the limit rotating member 40 and the gear member 50 return to the meshing position, the elastic member 60 releases the elastic force, so that the engagement between the gear member 50 and the limit rotating member 40 is more stable.

As shown in FIG. 1 to FIG. 5, the present application also provides an LED wall lamp, including the above-mentioned angle adjustable structure, a lamp body base 110 and a light-emitting cover 120. The lamp body base 110 is connected to a back side of the lamp body shell 10, and the light-emitting cover 120 is connected to a front side of the lamp body shell 10.

The lamp body shell 10 is connected to the light-emitting cover 120 through a plurality of third connecting members 130. The first side of the lamp body base 110 is hinged to the lamp body shell 10, and the second side of the lamp body base 110 is connected to the lamp body shell 10 through a fourth connecting member 140.

The lengths of the first side and the second side are less than a preset length value, which can be understood as the first side and the second side are shorter sides. The first side and the second side can be different sides of the lamp body base 110.

The lamp body base 110 refers to the base at the bottom of the lamp body, the lamp body base 110 plays a role of fixing and supporting. The light-emitting cover 120 can be used to protect the light source and adjust the distribution of light, thereby improving the lighting effect.

The lamp body base 10 and the light-emitting cover 120 are connected by the third connecting member 130. The third connecting member 130 is provided, so that the lamp body base 10 and the light-emitting cover 120 are detachably connected, which is convenient for disassembly and installation. The third connecting member 130 can be a third fixing screw, which can achieve a good fixing effect between the lamp body base 10 and the light-emitting cover 120.

One side of the lamp body shell 10 is hinged to the first side of the lamp body base 110, so that the lamp body shell 10 can be rotated directionally along the short side of the lamp body base 110, thereby facilitating the opening and closing of the lamp body shell 10 and also facilitating the disassembly and installation of components. The second side of the lamp body base 110 is connected to the movable end of the lamp body shell 10 through the fourth connecting member 140 to ensure a good closing effect. The fourth connecting member 140 is a fourth fixing screw, which can well fix the lamp body shell 10 and the lamp body base 110.

A third waterproof ring 150 is provided between the light-emitting cover 120 and the lamp body shell 10. Based on the third waterproof ring 150 being provided, a good waterproof effect can be achieved, and the service life of the lamp can be extended. The third waterproof ring 150 can well waterproof the junction between the light-emitting cover 120 and the lamp body shell 10.

The present application also has the following beneficial effects.

Firstly, by using a tool to twist the limit rotating member reserved in the external structure, the internal structure angle can be adjusted to change the illumination area and distance under the standard light distribution.

Secondly, the separated internal and external structures can adjust the angle of the light source structure. At the same time, it does not affect the waterproof performance of the lamp.

Thirdly, the heat dissipation of the light source and the heat dissipation of the power supply are separated to achieve excellent heat dissipation performance and extend the service life of the lamp.

Lastly, the internal structure of the wall lamp shaft can accurately adjust the angle, and the elastic force of the spring can better lock the angle.

The above contents are only some embodiments of the present application, and do not limit the scope of the present application. All equivalent structural changes made by using the contents of the present application specification and drawings under the inventive concept of the present application, or directly/indirectly applied in other related technical fields are included in the scope of the present application.

1. An angle adjustable structure, comprising:
a lamp body shell;
a heat dissipation component disposed in the lamp body shell;
a first connecting member, wherein the first connecting member is at least partially connected to one end of the heat dissipation component along a first direction;
a limit rotating member, wherein the limit rotating member is provided concentrically with the first connecting member along the first direction, and the limit rotating member is connected to one end of the heat dissipation component away from the first connecting member;
a gear member, wherein the gear member is sleeved on the limit rotating member, and one side of the gear member is meshed with the limit rotating member;
an elastic member, wherein the elastic member is sleeved on the limit rotating member, and the elastic member is abutted against a side of the gear component away from the limiting rotating component; and
a second connecting member, wherein the second connecting member is penetrated and embedded in the limit rotating member and is at least partially connected to one end of the heat dissipation component away from the first connecting member;
wherein one end of the heat dissipation component is configured to cooperate with the lamp body shell through the first connecting member to form a non-embedded fixed structure, and the other end of the heat dissipation component is configured to cooperate with the lamp body shell through the limit rotating member, the gear member, the elastic member and the second connecting member to form an embedded fixed structure; and
an inner wall of the limit rotating member is evenly provided with a plurality of first teeth along a circumferential direction of the limit rotating member; the gear member is evenly provided with a plurality of second teeth along a circumferential direction of the gear member, and the first teeth on the limit rotating member are respectively meshed with the second teeth on the gear member.

2. (canceled)

3. The angle adjustable structure of claim 1, wherein the first connecting member comprises a first portion and a second portion; a limiting recess is provided on one side of the lamp body shell, and the limiting recess comprises a first limiting recess and a second limiting recess; the first limiting recess is configured to accommodate the first portion, and the second limiting recess is configured to accommodate the second portion.

4. The angle adjustable structure of claim 3, wherein a depth of the first limiting recess is greater than a depth of the second limiting recess.

5. The angle adjustable structure of claim 3, wherein the limiting recess is provided with a limiting baffle, and the limiting baffle is configured to limit the first connecting member.

6. The angle adjustable structure of claim 1, wherein a limiting hole matching with the limit rotating member is provided on a side of the lamp body shell away from the first connecting member.

7. The angle adjustable structure of claim 6, wherein at least one step is provided at the limiting hole.

8. The angle adjustable structure of claim 7, wherein a bottom of the limiting hole is provided with an annular protrusion, and the annular protrusion is configured to cooperate with the at least one step to form a limiting groove.

9. The angle adjustable structure of claim 7, wherein an inner wall of the at least one step is provided with a first limit clamp for limiting the limit rotating member and a second limit clamp for limiting the gear member.

10. The angle adjustable structure of claim 1, wherein a limiting protrusion is provided at one end of the heat dissipation component close to the limit rotating member, and the limiting protrusion is plugged into the bottom of the limit rotating member; at least one positioning protrusion is provided at the limiting protrusion; at least one positioning recess is provided at the bottom of the limit rotating member, and each positioning protrusion is respectively engaged in a corresponding positioning recess.

11. The angle adjustable structure of claim 10, wherein an outer surface of the limit rotating member is provided with a marking arrow corresponding to the positioning recess.

12. The angle adjustable structure of claim 1, wherein a first waterproof ring is provided between the limit rotating member and the second connecting member, and a second waterproof ring is provided between the limit rotating member and the lamp body shell.

13. A light emitting diode (LED) wall light, comprising:
the angle adjustable structure of claim 1;
a lamp body base; and
a light-emitting cover;
wherein the lamp body base is connected to a back side of the lamp body shell, and the light-emitting cover is connected to a front side of the lamp body shell.

14. The LED wall light of claim 13, wherein a third waterproof ring is provided between the light-emitting cover and the lamp body shell.
